(19) United States
(12) Patent Application Publication
(10) Pub. No.: US 2025/0180908 A1
(43) Pub. Date: Jun. 5, 2025

(54) OPTICAL WAVEGUIDE STRUCTURE, OPTICAL WAVEGUIDE MODULE AND HEAD-MOUNTED DISPLAY DEVICE

(71) Applicants: Lemon Inc., Grand Cayman (KY); Beijing Zitiao Network Technology Co., Ltd., Beijing (CN)

(72) Inventors: Peng ZHANG, Los Angeles, CA (US); Wen XIONG, Beijing (CN)

(21) Appl. No.: 18/966,742

(22) Filed: Dec. 3, 2024

(30) Foreign Application Priority Data
Dec. 4, 2023 (CN) 202311645179.1

(51) Int. Cl. G02B 27/01

(52) U.S. Cl. CPC G02B 27/0172

(57) ABSTRACT

The present application discloses an optical waveguide structure, an optical waveguide module and a head-mounted display device. The optical waveguide structure of the embodiments of the present application comprises a waveguide substrate, an in-coupling grating and a recovery grating. The in-coupling grating is configured to in-couple input light rays into the waveguide substrate to transmit the light rays. The diffraction grating is configured to perform pupil expansion on the light rays transmitted in the waveguide substrate and out-couple the light rays.

### CROSS REFERENCE TO RELATED APPLICATION

This application claims priority from Chinese Patent Application No. 202311645179.1, filed on Dec. 4, 2023, the contents of which are hereby incorporated by reference in their entirety for all purposes.

### TECHNICAL FIELD

The present application relates to the technical field of optical waveguides, in particular to an optical waveguide structure, an optical waveguide module and a head-mounted display device.

### BACKGROUND

An optical waveguide is an important component of an Augmented Reality (AR) display device. The basic principle of the optical waveguide is that the light emitted by an optical engine is coupled to the optical waveguide, and light power is ensured not to be lost through total reflection when the light rays propagate in the waveguide until the light rays are out-coupled at the position of the human eyes.

### SUMMARY

An optical waveguide structure according to an embodiment of the present application includes:
a waveguide substrate;
an in-coupling grating configured to in-couple input light rays into the waveguide substrate to transmit the light rays;
a diffraction grating configured to perform pupil expansion on the light rays transmitted in the waveguide substrate and out-couple the light rays; and
a recovery grating configured to reflect the light rays which are not out-coupled and are transmitted to the recovery grating back to the diffraction grating, wherein the recovery grating is configured such that a wave vector space formed by at least portion of input light rays, after interacting with the in-coupling grating, the diffraction grating and the recovery grating, is closed.

In some embodiments, the in-coupling grating is configured to provide an in-coupling wave vector through which the input light rays are coupled into the waveguide substrate and transmitted;
the diffraction grating is configured to provide a first wave vector and a second wave vector, and the light rays transmitted in the waveguide substrate are subject to pupil expansion and out-coupled through the first wave vector and the second wave vector;
the recovery grating is configured to provide a recovery wave vector to reflect the light rays interacted with the first wave vector or the second wave vector and transmitted to the recovery grating back to the diffraction grating, and the recovery wave vector is configured such that a wave vector space formed by at least portion of the input light rays, after passing through the in-coupling wave vector, the first wave vector or the second wave vector, the recovery wave vector and again the first wave vector and the second wave vector, is closed.

In some embodiments, the diffraction grating includes a first grating, a second grating, and a third grating, where the first grating and the second grating are respectively disposed on opposite sides of the third grating, the first grating is at least configured to provide the first wave vector, the second grating is at least configured to provide the second wave vector, and the third grating is configured to provide the first wave vector or the second wave vector.

In some embodiments, the recovery grating includes a first recovery grating disposed on a side of the third grating on which the first grating is disposed;
the first recovery grating is configured to provide a first recovery wave vector to reflect the light rays interacted with the second wave vector and transmitted to the first recovery grating back to the diffraction grating, the first recovery wave vector being configured such that a wave vector space formed by at least a portion of the input light rays, after passing through the in-coupling wave vector, the second wave vector, the first recovery wave vector, and again the first wave vector and the second wave vector, is closed.

In certain embodiments, the first recovery wave vector is a wave vector difference between the first wave vector and the second wave vector.

In some embodiments, the recovery grating includes a second recovery grating disposed on a side of the third grating on which the second grating is disposed;
the second recovery grating is configured to provide a second recovery wave vector to reflect the light rays interacted with the first wave vector and transmitted to the second recovery grating back to the diffraction grating, the second recovery wave vector being configured such that a wave vector space formed by at least a portion of the input light rays, after passing through the in-coupling wave vector, the first wave vector, the second recovery wave vector, and again the first wave vector and the second wave vector, is closed.

In certain embodiments, the second recovery wave vector is a wave vector difference between the second wave vector and the first wave vector.

In some embodiments, the in-coupling grating is configured to provide an in-coupling wave vector through which the input light rays are coupled into the waveguide substrate and transmitted;
the diffraction grating is configured to provide a first wave vector and a second wave vector, and light rays transmitted in the waveguide substrate are subject to pupil expansion and out-coupled through the first wave vector and the second wave vector;
the recovery grating is configured to provide a recovery wave vector to reflect the light rays transmitted to the recovery grating without interacting with the first wave vector and the second wave vector back to the diffraction grating, the recovery wave vector being configured such that a wave vector space formed by at least a portion of the input light rays, after passing through the in-coupling wave vector, the recovery wave vector, and the first wave vector and the second wave vector, is closed.

In some embodiments, the recovery grating includes a third recovery grating disposed on a side of the diffraction grating opposite to the in-coupling grating;
the third recovery grating is provide a third recovery wave vector to reflect the light rays transmitted to the third recovery grating without interacting with the first wave vector and the second wave vector back to the diffraction grating, the third recovery wave vector being configured such that a wave vector space formed by at least a portion of the input light rays, after passing through the in-coupling wave vector, the third recovery wave vector, and the first wave vector and the second wave vector, is closed.

In certain embodiments, the third recovery wave vector is twice the sum of the first wave vector and the second wave vector.

The optical waveguide module of the embodiment of the present application includes:
the optical waveguide structure of any of the above embodiments; and
an optical engine configured to transmit input light rays to the in-coupling grating.

A head-mounted display device according to an embodiment of the present application includes the optical waveguide module according to the above embodiment.

Additional aspects and advantages of the present application will be set forth in part in the description which follows and, in part, will be obvious from the description, or may be learned by practice of the present application.

### BRIEF DESCRIPTION OF THE DRAWINGS

In order to more clearly illustrate the embodiments of the present application or the technical solutions in the prior art, the drawings used in the embodiments or the prior art descriptions will be briefly described below, it is obvious that the drawings in the following description are only some embodiments of the present application, and it is also possible for those skilled in the art to obtain other drawings based on the structures shown in the drawings without creative efforts. Wherein:

FIG. 1 is a schematic diagram of an optical waveguide structure according to certain embodiments of the present application;

FIG. 2 is a schematic structural diagram of an optical waveguide module according to certain embodiments of the present application;

FIG. 3 is a schematic principle diagram of an optical waveguide structure according to certain embodiments of the present application;

FIG. 4 is a schematic diagram of a portion of an optical waveguide structure with light rays not out-coupled according to some embodiments of the present application;

FIG. 5 is a schematic diagram of an optical waveguide structure according to certain embodiments of the present application;

FIG. 6 is a schematic diagram of an optical waveguide structure according to certain embodiments of the present application;

FIG. 7 is a schematic diagram of an optical waveguide structure according to certain embodiments of the present application;

FIG. 8 is a schematic diagram of an optical waveguide structure according to certain embodiments of the present application;

FIG. 9 is a schematic diagram of a portion of an optical waveguide structure with light rays not out-coupled according to some embodiments of the present application;

FIG. 10 is a schematic diagram of an optical waveguide structure according to certain embodiments of the present application;

FIG. 11 is a schematic diagram of a head-mounted display device according to some embodiments of the present application.

### DETAILED DESCRIPTION

Reference will now be made in detail to embodiments of the present application, examples of which are illustrated in the accompanying drawings, wherein like reference numerals refer to the same or similar elements or elements having the same or similar functions throughout the present application. The embodiments described below with reference to the accompanying drawings are illustrative only for the purpose of explaining the present application and are not to be construed as limiting the present application.

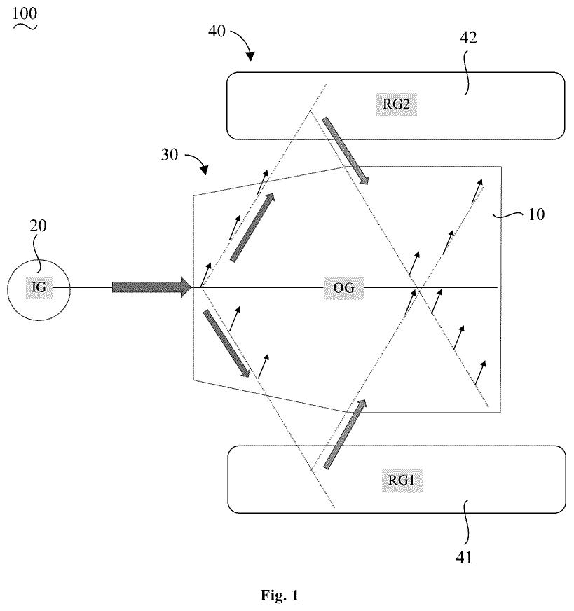

Referring to FIG. 1, an optical waveguide structure 100 is provided according to an embodiment of the present application. The optical waveguide structure 100 includes a waveguide substrate 10, an in-coupling grating 20, a diffraction grating 30 and a recovery grating 40. The in-coupling grating 20 is configured to couple and transmit input light rays into the waveguide substrate 10. The diffraction grating 30 is configured to perform pupil expansion on the light rays traveling in the waveguide substrate 10 and out-couple the light rays. The recovery grating 40 is configured to reflect light rays that are not out-coupled and are transmitted to the recovery grating 40 back to the diffraction grating 30. Wherein, the recovery grating 40 is configured such that a wave vector space formed by at least portion of input light rays, after interacting with the in-coupling grating 20, the diffraction grating 30 and the recovery grating 40, is closed. The diffraction grating 30 may be an out-coupling grating, or a turning and out-coupling grating, etc.

In the optical waveguide structure 100 according to the embodiment of the present application, by additionally arranging the recovery grating 40, the light rays that are not out-coupled and are transmitted to the recovery grating 40 are reflected to the diffraction grating 30 for recovery. The recovery grating 40 is configured such that a wave vector space formed by at least portion of input light rays, after interacting with the in-coupling grating 20, the diffraction grating 30 and the recovery grating 40, is closed. In this manner, this portion of the input light rays can be out-coupled to human eyes, thereby greatly improving the optical waveguide efficiency.

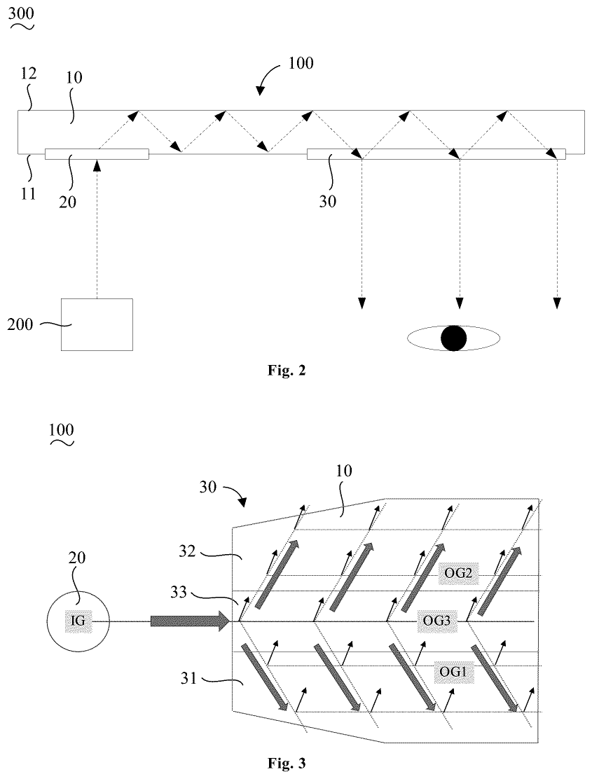

Referring to FIGS. 2 and 3, in the embodiment of the present application, the transmission process of the light rays may be as follows: the optical engine 200 emits the input light rays toward the in-coupling grating 20, for example, the optical engine 200 emits the input light rays toward the in-coupling grating 20 in a direction perpendicular to the paper surface in FIG. 3; the input light rays are coupled into the waveguide substrate 10 through the in-coupling grating 20 and are transmitted, wherein the transmission of the light rays in the waveguide substrate 10 includes total reflection; the light rays transmitted in the waveguide substrate 10 are subject to pupil expansion and out-coupled by the diffraction grating 30, for example, the light rays transmitted in the waveguide substrate 10 are subject to pupil expansion in one dimension and/or two dimension by the diffraction grating 30 and out-coupled from the diffraction grating 30 in the direction perpendicular to the paper surface in FIG. 3, so as to be received by the human eye.

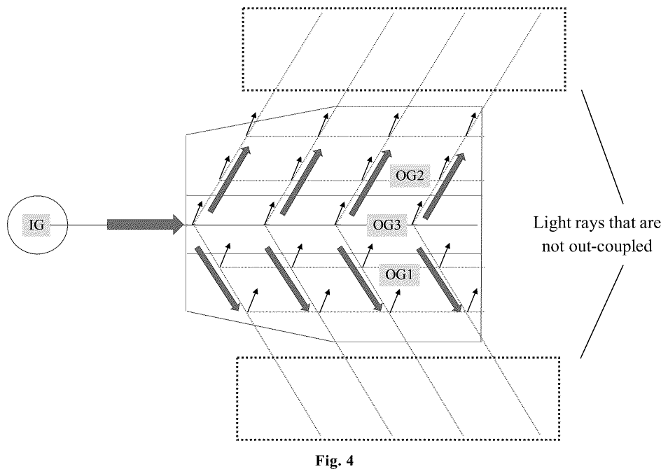

Referring to FIG. 4, it is found that, no matter what design of the diffraction grating and what kind of transmission process of the light rays are, there are always wasted light rays (light rays corresponding to zero-order reflection) that are not out-coupled through the diffraction grating. Referring to FIG. 1, for this portion of light rays, the embodiment of the present application additionally designs a recovery grating 40, which reflects this portion of light rays back to the diffraction grating 30 for recovery, so as to improve the efficiency of the optical waveguide. In order to out-couple this portion of light rays successfully, the recovery grating 40 needs to satisfy a condition that a wave vector space formed by at least portion of input light rays, after interacting with the in-coupling grating 20, the diffraction grating 30 and the recovery grating 40, is closed. That is, the total wave vector obtained by at least portion of the input light rays, after interacting with the in-coupling grating 20, the diffraction grating 30 and the recovery grating 40 is made to be 0, otherwise dispersion tends to occur. In the embodiment of the present application, the recovery grating 40 may be disposed on a side surface of the diffraction grating 30, and the number of the recovery grating 40 may be one or more, which is not limited herein.

Referring to FIGS. 1 and 3, in some embodiments, the in-coupling grating 20 is configured to provide an in-coupling wave vector through which input light rays are coupled into the waveguide substrate 10 and are transmitted. The diffraction grating 30 is configured to provide a first wave vector and a second wave vector through which light rays propagating in the waveguide substrate 10 are subject to pupil expansion and are out-coupled. The recovery grating 40 is configured to provide a recovery wave vector to reflect the light rays interacted with the first wave vector or the second wave vector and transmitted to the recovery grating 40 back to the diffraction grating 30. The recovery wave vector is configured such that a wave vector space formed by at least portion of the input light rays, after passing through the in-coupling wave vector, the first wave vector or the second wave vector, the recovery wave vector and again the first wave vector and the second wave vector, is closed.

Specifically, in the example of the present application, the in-coupling wave vector is denoted by \vec{k}_{ig}, the first in-coupling wave vector is denoted by \vec{k}₁, the second in-coupling wave vector is denoted by \vec{k}₂, and the recovery wave vector is denoted by Δ\vec{k}. The input light rays emitted from the optical engine 200 are coupled into the waveguide substrate 10 through the wave vector \vec{k}_{ig} provided by the in-coupling grating 20 and are transmitted. The light rays transmitted in the waveguide substrate 10 pass through the wave vector \vec{k}₁ provided by the diffraction grating 30, and are subject to one-dimensional pupil expansion; the light rays subject to the one-dimensional pupil expansion are subject to pupil expansion in two dimensions by the wave vector \vec{k}₂ provided by the diffraction grating 30 and are out-coupled. Alternatively, the light rays transmitted in the waveguide substrate 10 pass through the wave vector \vec{k}₂ provided by the diffraction grating 30, and are subject to one-dimensional pupil expansion; the light rays passing through the one-dimensional pupil expansion are subject to two-dimensional pupil expansion by the wave vector \vec{k}₁ provided by the diffraction grating 30 and are out-coupled.

For most of the light rays that can be directly out-coupled by the diffraction grating 30 (i.e., the light rays that can be out-coupled without passing through the recovery grating 40), the following conditional expression is satisfied: \vec{k}_{ig}+\vec{k}₁+\vec{k}₂=0. For a few light rays that are not out-coupled by the diffraction grating 30 (e.g., light rays that, for various reasons, only interact with the wave vectors \vec{k}₁ provided by the diffraction grating 30 and do not interact with the wave vectors \vec{k}₂ provided by the diffraction grating 30, or light rays that only interact with the wave vectors provided \vec{k}₂ by the diffraction grating 30 and do not interact with the wave vectors \vec{k}₁ provided by the diffraction grating 30), it is necessary to reflect them by the wave vectors Ok provided by the recovery grating 40 back to the diffraction grating 30 so as to be out-coupled by the wave vectors \vec{k}₁ and \vec{k}₂ provided by the diffraction grating 30 again. Therefore, in the embodiment of the present application, Δ\vec{k} is configured such that a wave vector space formed by at least portion of the input light rays, after passing through \vec{k}_{ig}, \vec{k}₁ or \vec{k}₂, Δ\vec{k} and again \vec{k}₁ and \vec{k}₂, is closed, to out-couple this portion of the light rays, thereby improving the optical waveguide efficiency. Meanwhile, because the light rays are still out-coupled by \vec{k}₁ and \vec{k}₂, the light rays can be emitted to human eyes along the original emitting angle, so that ghost images caused by unnecessary out-coupling are avoided.

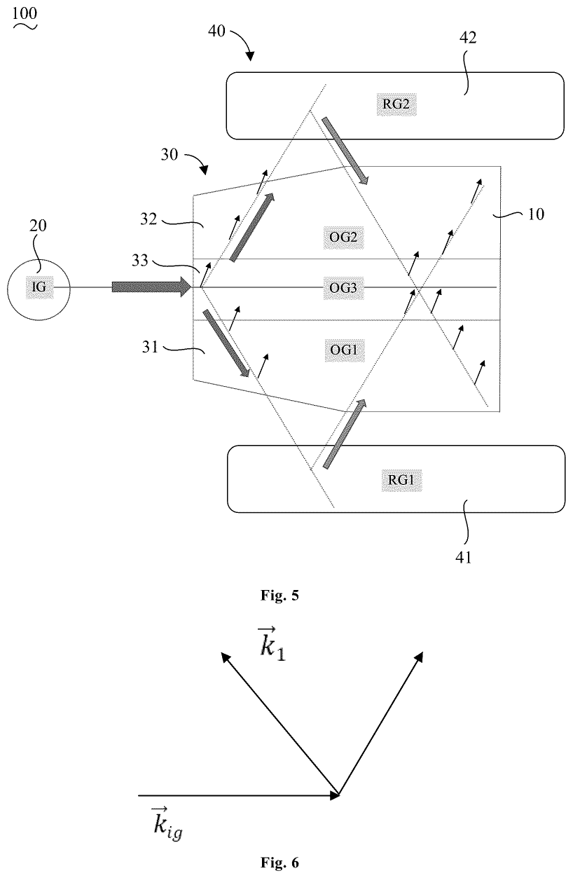

Referring to FIGS. 3 and 5, in some embodiments, the diffraction grating 30 includes a first grating 31, a second grating 32, and a third grating 33. The first grating 31 and the second grating 32 are respectively disposed on two opposite sides of the third grating 33. The first grating 31 is at least configured to provide a first wave vector, the second grating 32 is at least configured to provide a second wave vector, and the third grating 33 is at least configured to provide the first wave vector or the second wave vector. Wherein, the first grating 31 is not limited to providing the first wave vector, and the second grating 32 is not limited to providing the second wave vector. For example, the first grating 31 may provide the first wave vector and the second wave vector at the same time, and the second grating 32 may also provide the first wave vector and the second wave vector at the same time.

In the embodiment of the present application, the diffraction grating 30 may be a one-dimensional and two-dimensional mixed grating. For example, the first grating 31 and the second grating 32 are one-dimensional gratings, and the third grating 33 is a two-dimensional grating. Of course, in other embodiments, the diffraction grating 30 may be a one-dimensional grating or a two-dimensional grating, which is not described herein.

In the present example, the in-coupling grating 20 is denoted by IG, the first grating 31 is denoted by OG1, the second grating 32 is denoted by OG2, and the third grating 33 is denoted by OG3. The one-dimensional grating OG2, the two-dimensional grating OG3, and the one-dimensional grating OG1 are laid in a flat manner, for example, in FIG. 3, from top to bottom. The plane where the one-dimensional grating OG2, the two-dimensional grating OG3 and the one-dimensional grating OG1 are located may be the first surface 11 or the second surface 12 of the waveguide substrate 10 in FIG. 2, that is, the arrangement direction of the one-dimensional grating OG2, the two-dimensional grating OG3 and the one-dimensional grating OG1 is a direction perpendicular to the paper surface in FIG. 2. For different stages of transmission of the light rays, the one-dimensional grating OG1, the one-dimensional grating OG2 and the two-dimensional grating OG3 can be used as a turning grating or an out-coupling grating, so that multiplexing of gratings is realized.

Referring to FIG. 3, in the embodiment of the present application, the input light rays emitted from the optical engine 200 is coupled into the waveguide substrate 10 and transmitted through the wave vector \vec{k}_{ig} provided by the in-coupling grating IG.

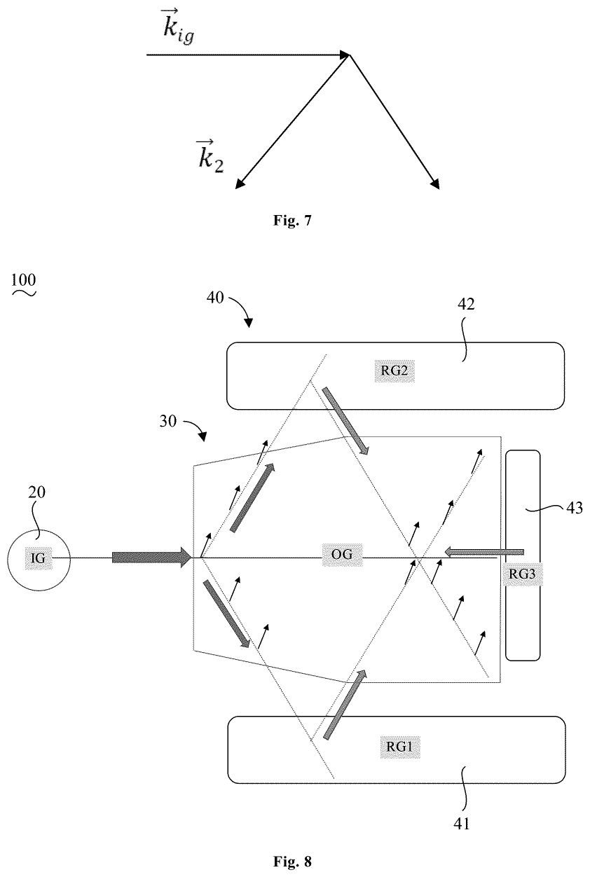

The light rays transmitted in the waveguide substrate 10 pass through a wave vector \vec{k}₁ or \vec{k}₂ provided by the diffraction grating 30, and are subject to one-dimensional pupil expansion. Specifically, the input light rays, after passing through the in-coupling grating IG, can be directly incident on the one-dimensional grating OG1, directly incident on the one-dimensional grating OG2, or directly incident on the two-dimensional grating OG3. For the first case, the input light rays are incident on the one-dimensional grating OG1 after passing through the in-coupling grating IG, and the OG1 provides a wave vector \vec{k}₁, and the light rays gets the wave vector \vec{k}₁ and propagates upward (as shown in FIG. 6); for the second case, the input light rays are incident on the one-dimensional grating OG2 after passing through the in-coupling grating IG, and the OG2 provides a wave vector \vec{k}₂, and the light rays gets the wave vector \vec{k}₂ and then propagates downward (as shown in FIG. 7); for the third case, the input light rays pass through the in-coupling grating IG and then are incident on the two-dimensional grating OG3, and the OG3 provides a wave vector \vec{k}₁ or \vec{k}₂, the light rays obtaining the wave vector \vec{k}₁ propagate upward (as shown in FIG. 6), and the light rays obtaining the wave vector \vec{k}₂ propagate downward (as shown in FIG. 7). In this stage of transmission of light rays, the one-dimensional grating OG1, the one-dimensional grating OG2, and the two-dimensional grating OG3 are all used as a turning grating.

The light rays subject to one-dimensional pupil expansion pass are subject to two-dimensional pupil expansion by the wave vector \vec{k}₁ or \vec{k}₂ provided by the diffraction grating 30 and are out-coupled. Specifically, for the first case, the upward-propagating light rays interact with the one-dimensional grating OG2 or the two-dimensional grating OG3 to obtain a wave vector \vec{k}₂, thereby being out-coupled from the waveguide substrate 10 (satisfying the conditional expression: \vec{k}_{ig}+\vec{k}₁+\vec{k}₂=0). For the second case, the downward-propagating light rays interact with the one-dimensional grating OG1 or the two-dimensional grating OG3 to obtain a wave vector \vec{k}₁, thereby being out-coupled from the waveguide substrate 10 (satisfying the conditional expression: \vec{k}_{ig}+\vec{k}₂+\vec{k}₁=0). For the third case, the upward propagating light rays interact with the one-dimensional grating OG2 to obtain a wave vector \vec{k}₂, so as to be out-coupled from the waveguide substrate 10 (satisfying the condition: \vec{k}_{ig}+\vec{k}₁+\vec{k}₂=0); the downward propagating light rays interact with the one-dimensional grating OG1 to obtain a wave vector \vec{k}₁, so as to be out-coupled from the waveguide substrate 10 (satisfying the condition: \vec{k}_{ig}+\vec{k}₂+\vec{k}₁=0). In this stage of transmission of light rays, the one-dimensional grating OG1, the one-dimensional grating OG2, and the two-dimensional grating OG3 all serve as out-coupling gratings.

It should be noted that the thick arrows in FIG. 3 represent the transmission of light rays in the waveguide substrate 10, and the thin arrows represent the light rays out-coupled from the waveguide substrate 10 (the out-coupling direction is, for example, the direction perpendicular to the paper surface). In addition, for convenience of illustration and distinction, the light path of the first case and the second case are not illustrated in FIG. 3, and only the light path of the third case is illustrated. It will be appreciated that the light path of the first case corresponds to the former case of the third case and that the light path of the second case corresponds to the latter case of the third case.

Referring to FIG. 5, in some embodiments, the recovery grating 40 includes a first recovery grating 41, and the first recovery grating 41 is disposed on a side of the third grating 33 on which the first grating 31 is disposed. The first recovery grating 41 is configured to provide a first recovery wave vector to reflect the light rays interacted with the second wave vector and transmitted to the first recovery grating 41 back to the diffraction grating 30. The first recovery wave vector is configured such that a wave vector space formed by at least a portion of the input light rays, after passing through the in-coupling wave vector, the second wave vector, the first recovery wave vector, and again the first wave vector and the second wave vector, is closed.

In the example of the present application, the first recovery grating 41 is denoted by RG1, and the first recovery wave vector is denoted by Δ\vec{k}₁. The first recovery wave vector Δ\vec{k}₁ is configured such that the total wave vector obtained by at least a portion of the input light rays, after interacting with \vec{k}_{ig}, \vec{k}₂, Δ\vec{k}₁, and again \vec{k}₁ and \vec{k}₂, to be 0. Therefore, the first recovery wave vector Δ\vec{k}₁ satisfies the conditional expression: \vec{k}_{ig}+\vec{k}₂+Δ\vec{k}₁+l\vec{k}₁+p\vec{k}₂=0, wherein l and p are integers, and further in view of the above conditional expression: \vec{k}_{ig}+\vec{k}₁+\vec{k}₂=0, the first recovery wave vector Δ\vec{k}₁ can be obtained. Optionally, the first recovery wave vector is a wave vector difference between the first wave vector and the second wave vector. That is, Δ\vec{k}₁=\vec{k}₁−\vec{k}₂, and meanwhile, l=0 and p=1. The grating design of the first recovery grating RG1 is the simplest, and not only can out-couple the at least portion of the input light rays to improve the optical waveguide efficiency, but also can make the light rays emit to human eyes along the original emitting angle, so as to avoid ghost images caused by unnecessary out-coupling.

Referring to FIG. 5, in some embodiments, the recovery grating 40 includes a second recovery grating 42, and the second recovery grating 42 is disposed on a side of the third grating 33 on which the second grating 32 is disposed. The second recovery grating 42 is configured to provide a second recovery wave vector to reflect the light rays interacted with the first wave vector and transmitted to the second recovery grating 42 back to the diffraction grating 30. The second recovery wave vector is configured such that a wave vector space formed by at least a portion of the input light rays, after passing through the in-coupling wave vector, the first wave vector, the second recovery wave vector, and again the first wave vector and the second wave vector, is closed.

In the example of the present application, the second recovery grating 42 is denoted by RG2, and the second recovery wave vector is denoted by Δ\vec{k}₂. The second recovery wave vector Δ\vec{k}₂ is configured such that that the total wave vector obtained by at least a portion of the input light rays, after interacting with \vec{k}_{ig}, \vec{k}₁, Δ\vec{k}₂, and again \vec{k}₁ and \vec{k}₂, to be 0. Therefore, the second recovery wave vector Δ\vec{k}₁ satisfies the conditional expression: \vec{k}_{ig}+\vec{k}₁+Δ\vec{k}₂+m\vec{k}₁+n\vec{k}₂=0, wherein m and n are integers, and further in view of the above conditional expression: \vec{k}_{ig}+\vec{k}₁+\vec{k}₂=0, the second recovery wave vector Δ\vec{k}₂ can be obtained. Optionally, the second recovery wave vector is a wave vector difference between the second wave vector and the first wave vector. That is, Δ\vec{k} 2=\vec{k}₂−\vec{k}₁, and meanwhile, m=1 and n=0. The grating design of the second recovery grating RG2 is the simplest, and not only can out-couple the at least portion of the input light rays to improve the optical waveguide efficiency, but also can make the light rays emit to human eyes along the original emitting angle, so as to avoid ghost images caused by unnecessary out-coupling.

Referring to FIG. 8, in some embodiments, the in-coupling grating 20 is configured to provide an in-coupling wave vector through which input light rays are coupled into the waveguide substrate 10 and are transmitted. The diffraction grating 30 is configured to provide a first wave vector and a second wave vector through which light rays propagating in the waveguide substrate 10 are subject to pupil expansion and are out-coupled. The recovery grating 40 is configured to provide a recovery wave vector to reflect light rays transmitted to the recovery grating 40 without interacting with the first wave vector and the second wave vector back to the diffraction grating 30. The recovery wave vectors are configured such that a wave vector space formed by at least a portion of the input light rays, after passing through the in-coupling wave vector, the recovery wave vector, and the first wave vector and the second wave vector, is closed.

Specifically, the embodiment of the present application is different from “the recovery wave vector is configured such that a wave vector space formed by at least portion of the input light rays, after passing through the in-coupling wave vector, the first wave vector or the second wave vector, the recovery wave vector and again the first wave vector and the second wave vector, is closed” in the aforementioned embodiment, in that the embodiment of the present application is used to recover the light rays transmitted to the recovery grating 40 without interacting with the first wave vector and the second wave vector, and this portion of the light rays are directly transmitted to the recovery grating 40 through the in-coupling wave vector \vec{k}_{ig} (i.e., transmitted to the right in the horizontal direction in FIG. 8).

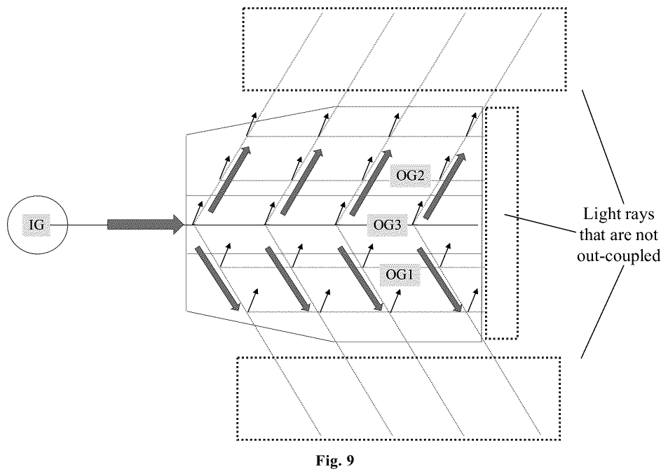

Referring to FIG. 9, for most of the light rays directly out-coupled from the diffraction grating 30 (i.e. the light rays out-coupled without passing through the recovery grating 40), the following conditional expression is still satisfied: \vec{k}_{ig}+\vec{k}₁+\vec{k}₂=0. For a few light rays that are not out-coupled through diffraction grating 30 (e.g., light rays that, for various reasons, do not interact with the wave vectors \vec{k}₁ and \vec{k}₂ provided by diffraction grating 30), it is necessary to reflect them by the wave vectors Δ\vec{k} provided by the recovery grating 40 back to the diffraction grating 30 so as to be out-coupled by the wave vectors \vec{k}₁ and \vec{k}₂ provided by the diffraction grating 30. Therefore, in the embodiment of the present application, Δ\vec{k} is configured such that a wave vector space formed by at least portion of the input light rays, after passing through \vec{k}_{ig}, Δ\vec{k} and \vec{k}₁ and \vec{k}₂, is closed, to out-couple this portion of the light rays, thereby improving the optical waveguide efficiency. Meanwhile, because the light rays are still out-coupled by \vec{k}₁ and \vec{k}₂, the light rays can be emitted to human eyes along the original emitting angle, so that ghost images caused by unnecessary out-coupling are avoided.

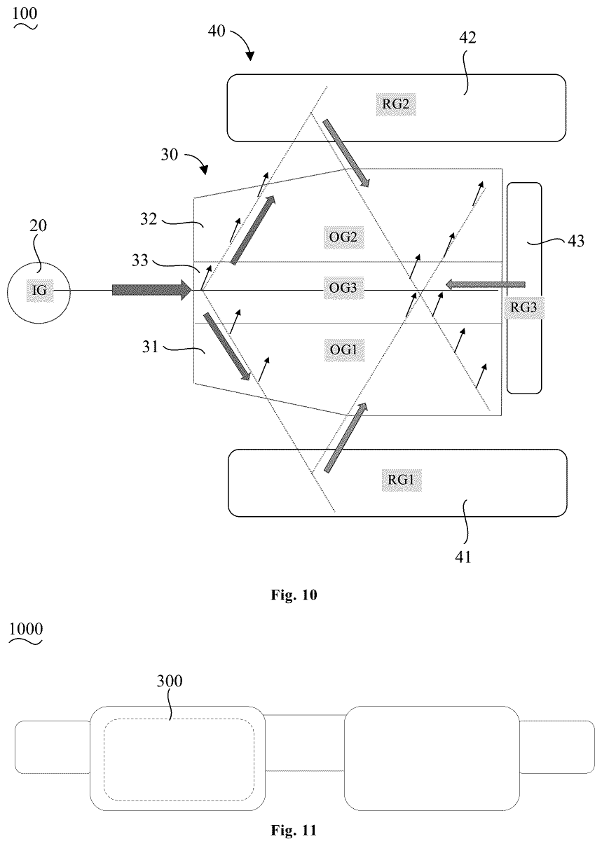

Referring to FIGS. 8 and 10, in some embodiments, the recovery grating 40 includes a third recovery grating 43, and the third recovery grating 43 is disposed on a side of the diffraction grating 30 opposite to the in-coupling grating 20. The third recovery grating 43 is configured to provide a third recovery wave vector to reflect the light rays transmitted to the third recovery grating 43 without interacting with the first wave vector and the second wave vector back to the diffraction grating 30. The third recovery wave vector is configured such that a wave vector space formed by at least a portion of the input light rays, after passing through the in-coupling wave vector, the third recovery wave vector, and the first wave vector and the second wave vector, is closed.

In the present application, the third recovery grating 43 is denoted by RG3, and the third recovery wave vector is denoted by Δ\vec{k}₃. The third recovery wave vector Δ\vec{k}₃ is configured such that the total wave vector obtained by at least a portion of the input light rays, after interacting with \vec{k}_{ig}, Δ\vec{k}₃, and \vec{k}₁ and \vec{k}₂, to be 0. In the embodiments of the present application, in order to reflect the light rays transmitted to the third recovery grating 43 back to the diffraction grating 30, the third recovery wave vector Δ\vec{k}₃ satisfies the conditional expression: Δ\vec{k}₃=−2\vec{k}_{ig}, and further in view of the above conditional expression: \vec{k}_{ig}+\vec{k}₁+\vec{k}₂=0, the third recovery wave vector Δ\vec{k}₃ can be obtained as: Δ\vec{k}₃=2(\vec{k}₁+\vec{k}₂). That is to say, the third recovery wave vector is twice the sum of the first wave vector and the second wave vector. The grating design of the third recovery grating RG3 is the simplest, and not only can out-couple the at least portion of the input light rays to improve the optical waveguide efficiency, but also can make the light rays emit to human eyes along the original emitting angle, so as to avoid ghost images caused by unnecessary out-coupling.

It should be noted that the first recovery grating 41, the second recovery grating 42, and the third recovery grating 43 may be disposed independently, or disposed in any combination, and are not limited herein. That is, the recovery grating 40 may include any one or more of the first recovery grating 41, the second recovery grating 42, and the third recovery grating 43. For example, the recovery grating 40 includes a first recovery grating 41; alternatively, the recovery grating 40 includes a second recovery grating 42; alternatively, the recovery grating 40 includes a first recovery grating 41 and a second recovery grating 42 (as shown in FIG. 5); alternatively, the recovery grating 40 includes a first recovery grating 41, a second recovery grating 42, and a third recovery grating 43 (as shown in FIG. 8), which are not illustrated herein. In addition, the first recovery grating 41, the second recovery grating 42, and the third recovery grating 43 may be disposed on the first surface 11, the second surface 12, or both the first surface 11 and the second surface 12 of the waveguide substrate 10 in FIG. 2.

The present embodiment has a greater degree of freedom in designing the recovery grating 40, and can be implemented as the previous embodiment, in which the first recovery grating 41, the second recovery grating 42, and the third recovery grating 43 are all one-dimensional gratings, and the corresponding wave vectors are Δ\vec{k}₁=\vec{k}₁−\vec{k}₂, Δ\vec{k}₂=\vec{k}₂−\vec{k}₁, Δ\vec{k} 3=2(\vec{k}₁+\vec{k}₂). Of course, the first recovery grating 41, the second recovery grating 42, and the third recovery grating 43 may be two-dimensional gratings, as long as the provided wave vectors correspondingly includes components including the above-described wave vectors. When the first recovery grating 41, the second recovery grating 42, and the third recovery grating 43 are all one-dimensional gratings, the grating structure design is simple, and no unnecessary component is contained.

As shown in table 1 below, the following are simulation results of the optical waveguide structure 100 according to the embodiment of the present application with respect to optical waveguide efficiency. As can be seen from table 1, the improvement of the optical waveguide efficiency is slightly different for different color lights after adding the recovery grating 40. However, for all color lights, the relative improvement of the optical waveguide efficiency after adding the recovery grating 40 exceeds 20%. The optical waveguide structure 100 according to the embodiment of the present application recovers the light rays that cannot be out-coupled, so as to greatly improve the optical waveguide efficiency. Furthermore, recovery grating 40 only adds some additional grating regions to waveguide surface and the processing difficulties will not be increased. The recovery grating 40 may also be compatible with any of the original grating designs.

TABLE 1

| Mean efficiency | | | |
|---|---|---|---|
| of the grating | Red light | Green light | Blue light |
| No RG | 1.97% | 2.63% | 2.70% |
| With RG | 2.44% | 3.24% | 3.28% |

Referring to FIG. 2, an optical waveguide module 300 is further provided by the present embodiment. The optical waveguide module 300 includes the optical waveguide structure 100 and the optical engine 200 of any of the above embodiments. The optical engine 200 is configured to emit input light rays to the in-coupling grating 20.

The optical waveguide module 300 according to the embodiment of the present application reflects the light rays that are not out-coupled and are transmitted to the recovery grating 40 back to the diffraction grating 30 for recovery through additionally arranging the recovery grating 40. The recovery grating 40 is configured such that a wave vector space formed by at least portion of input light rays, after interacting with the in-coupling grating 20, the diffraction grating 30 and the recovery grating 40, is closed. In this manner, this portion of the input light rays can be out-coupled to human eyes, thereby greatly improving the optical waveguide efficiency.

Referring to FIG. 11, a head-mounted display device 1000 is further provided by the embodiments of the present application. The head-mounted display device 1000 includes the optical waveguide module 300 of the above embodiment. The head-mounted display device 1000 is, for example, an AR display device.

The head-mounted display device 1000 according to the embodiment of the present application reflects the light rays that are not out-coupled and are transmitted to the recovery grating 40 back to the diffraction grating 30 for recovery through additionally arranging the recovery grating 40. The recovery grating 40 is configured such that a wave vector space formed by at least portion of input light rays, after interacting with the in-coupling grating 20, the diffraction grating 30 and the recovery grating 40, is closed. In this manner, this portion of the input light rays can be out-coupled to human eyes, thereby greatly improving the optical waveguide efficiency.

In the description of the present application, it is to be understood that the terms “center”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, and the like, indicate orientations or positional relationships based on those shown in the drawings, merely for convenience of description and simplification of the description, and do not indicate or imply that the device or element referred to must have a particular orientation, be constructed in a particular orientation, and be operated, and thus, are not to be construed as limiting the present application. Furthermore, the terms “first” and “second” are used for descriptive purposes only and are not to be construed as indicating or implying relative importance or to implicitly indicate the number of technical features indicated. Thus, a feature defined as “first” or “second” may explicitly or implicitly include one or more features. In the description of the present application, “a plurality” means two or more unless specifically defined otherwise.

In the description of the present application, it should be noted that, unless otherwise explicitly specified or limited, the terms “mounted”, “connected”, and “connecting” are to be construed broadly and may be, for example, fixedly connected, detachably connected, or integrally connected; can be mechanically or electrically connected; they may be directly connected or indirectly connected through intervening media, or may be connected through the use of two elements or the interaction of two elements. The specific meanings of the above terms in the present application can be understood according to specific situations by those of ordinary skill in the art.

In the present application, unless expressly stated or limited otherwise, the recitation of a first feature “on” or “under” a second feature may include the recitation of the first and second features being in direct contact, and may also include the recitation that the first and second features are not in direct contact, but are in contact via another feature between them. Also, the first feature “on”, “above” and “over” the second feature may include the first feature being directly above and obliquely above the second feature, or simply indicating that the first feature is at a higher level than the second feature. The first feature “beneath”, “under” and “below” the second feature includes the first feature being directly beneath and obliquely beneath the second feature, or simply indicating that the first feature is at a lesser elevation than the second feature.

The above disclosure provides many different embodiments, or examples, for implementing different features of the present application. The foregoing description of specific example components and arrangements has been presented to simplify the present disclosure. Of course, they are merely examples and are not intended to limit the present application. Moreover, the present application may repeat reference numerals and/or reference letters in the various examples, which have been repeated for purposes of simplicity and clarity and do not in themselves dictate a relationship between the various embodiments and/or configurations discussed. In addition, the present application provides examples of various specific processes and materials, but one of ordinary skill in the art may recognize the application of other processes and/or the use of other materials.

In the description of the present specification, reference to the description of “one embodiment”, “some embodiments”, “illustrative embodiments”, “examples”, “specific examples”, “some examples”, or the like, means that a particular feature, structure, material, or characteristic described in connection with the embodiment or example is included in at least one embodiment or example of the present application. In this specification, schematic representations of the above terms do not necessarily refer to the same embodiment or example. Furthermore, the particular features, structures, materials, or characteristics described may be combined in any suitable manner in any one or more embodiments or examples.

While embodiments of the present application have been shown and described above, it will be understood by those of ordinary skill in the art that: various changes, modifications, substitutions and alterations can be made to the embodiments without departing from the principles and spirit of the present application, the scope of which is defined by the claims and their equivalents.

What is claimed is:

1. An optical waveguide structure, comprising:
a waveguide substrate;
an in-coupling grating configured to in-couple input light rays into the waveguide substrate to transmit the light rays;
a diffraction grating configured to perform pupil expansion on the light rays transmitted in the waveguide substrate and out-couple the light rays; and
a recovery grating configured to reflect the light rays which are not out-coupled and are transmitted to the recovery grating back to the diffraction grating, wherein the recovery grating is configured such that a wave vector space formed by at least portion of input light rays, after interacting with the in-coupling grating, the diffraction grating and the recovery grating, is closed.

2. The optical waveguide structure according to claim 1, wherein the in-coupling grating is configured to provide an in-coupling wave vector through which the input light rays are coupled into the waveguide substrate and transmitted;
the diffraction grating is configured to provide a first wave vector and a second wave vector, and the light rays transmitted in the waveguide substrate are subject to pupil expansion and out-coupled through the first wave vector and the second wave vector;
the recovery grating is configured to provide a recovery wave vector to reflect the light rays interacted with the first wave vector or the second wave vector and transmitted to the recovery grating back to the diffraction grating, and the recovery wave vector is configured such that a wave vector space formed by at least portion of the input light rays, after passing through the in-coupling wave vector, the first wave vector or the second wave vector, the recovery wave vector and again the first wave vector and the second wave vector, is closed.

3. The optical waveguide structure according to claim 2, wherein the diffraction grating comprises a first grating, a second grating, and a third grating, where the first grating and the second grating are respectively disposed on opposite sides of the third grating, the first grating is at least configured to provide the first wave vector, the second grating is at least configured to provide the second wave vector, and the third grating is configured to provide the first wave vector or the second wave vector.

4. The optical waveguide structure according to claim 3, wherein the recovery grating comprises a first recovery grating disposed on a side of the third grating on which the first grating is disposed;
the first recovery grating is configured to provide a first recovery wave vector to reflect the light rays interacted with the second wave vector and transmitted to the first recovery grating back to the diffraction grating, the first recovery wave vector being configured such that a wave vector space formed by at least a portion of the input light rays, after passing through the in-coupling wave vector, the second wave vector, the first recovery wave vector, and again the first wave vector and the second wave vector, is closed.

5. The optical waveguide structure according to claim 4, wherein the first recovery wave vector is a wave vector difference between the first wave vector and the second wave vector.

6. The optical waveguide structure according to claim 3, wherein the recovery grating comprises a second recovery grating disposed on a side of the third grating on which the second grating is disposed;
the second recovery grating is configured to provide a second recovery wave vector to reflect the light rays interacted with the first wave vector and transmitted to the second recovery grating back to the diffraction grating, the second recovery wave vector being configured such that a wave vector space formed by at least a portion of the input light rays, after passing through the in-coupling wave vector, the first wave vector, the second recovery wave vector, and again the first wave vector and the second wave vector, is closed.

7. The optical waveguide structure according to claim 6, wherein the second recovery wave vector is a wave vector difference between the second wave vector and the first wave vector.

8. The optical waveguide structure according to claim 1, wherein the in-coupling grating is configured to provide an in-coupling wave vector through which the input light rays are coupled into the waveguide substrate and transmitted;
the diffraction grating is configured to provide a first wave vector and a second wave vector, and light rays transmitted in the waveguide substrate are subject to pupil expansion and out-coupled through the first wave vector and the second wave vector;
the recovery grating is configured to provide a recovery wave vector to reflect the light rays transmitted to the recovery grating without interacting with the first wave vector and the second wave vector back to the diffraction grating, the recovery wave vector being configured such that a wave vector space formed by at least a portion of the input light rays, after passing through the in-coupling wave vector, the recovery wave vector, and the first wave vector and the second wave vector, is closed.

9. The optical waveguide structure according to claim 8, wherein the recovery grating comprises a third recovery grating disposed on a side of the diffraction grating opposite to the in-coupling grating;
the third recovery grating is provide a third recovery wave vector to reflect the light rays transmitted to the third recovery grating without interacting with the first wave vector and the second wave vector back to the diffraction grating, the third recovery wave vector being configured such that a wave vector space formed by at least a portion of the input light rays, after passing through the in-coupling wave vector, the third recovery wave vector, and the first wave vector and the second wave vector, is closed.

10. The optical waveguide structure according to claim 9, wherein the third recovery wave vector is twice the sum of the first wave vector and the second wave vector.

11. An optical waveguide module, comprising:
an optical waveguide structure; and
an optical engine configured to transmit input light rays to the in-coupling grating, wherein the optical waveguide structure comprises:
a waveguide substrate;
an in-coupling grating configured to in-couple input light rays into the waveguide substrate to transmit the light rays;
a diffraction grating configured to perform pupil expansion on the light rays transmitted in the waveguide substrate and out-couple the light rays; and
a recovery grating configured to reflect the light rays which are not out-coupled and are transmitted to the recovery grating back to the diffraction grating, wherein the recovery grating is configured such that a wave vector space formed by at least portion of input light rays, after interacting with the in-coupling grating, the diffraction grating and the recovery grating, is closed.

12. The optical waveguide module according to claim 11, wherein the in-coupling grating is configured to provide an in-coupling wave vector through which the input light rays are coupled into the waveguide substrate and transmitted;
the diffraction grating is configured to provide a first wave vector and a second wave vector, and the light rays transmitted in the waveguide substrate are subject to pupil expansion and out-coupled through the first wave vector and the second wave vector;
the recovery grating is configured to provide a recovery wave vector to reflect the light rays interacted with the first wave vector or the second wave vector and transmitted to the recovery grating back to the diffraction grating, and the recovery wave vector is configured such that a wave vector space formed by at least portion of the input light rays, after passing through the in-coupling wave vector, the first wave vector or the second wave vector, the recovery wave vector and again the first wave vector and the second wave vector, is closed.

13. The optical waveguide module according to claim 12, wherein the diffraction grating comprises a first grating, a second grating, and a third grating, where the first grating and the second grating are respectively disposed on opposite sides of the third grating, the first grating is at least configured to provide the first wave vector, the second grating is at least configured to provide the second wave vector, and the third grating is configured to provide the first wave vector or the second wave vector.

14. The optical waveguide module according to claim 13, wherein the recovery grating comprises a first recovery grating disposed on a side of the third grating on which the first grating is disposed;
the first recovery grating is configured to provide a first recovery wave vector to reflect the light rays interacted with the second wave vector and transmitted to the first recovery grating back to the diffraction grating, the first recovery wave vector being configured such that a wave vector space formed by at least a portion of the input light rays, after passing through the in-coupling wave vector, the second wave vector, the first recovery wave vector, and again the first wave vector and the second wave vector, is closed.

15. The optical waveguide module according to claim 14, wherein the first recovery wave vector is a wave vector difference between the first wave vector and the second wave vector.

16. The optical waveguide module according to claim 13, wherein the recovery grating comprises a second recovery grating disposed on a side of the third grating on which the second grating is disposed;
the second recovery grating is configured to provide a second recovery wave vector to reflect the light rays interacted with the first wave vector and transmitted to the second recovery grating back to the diffraction grating, the second recovery wave vector being configured such that a wave vector space formed by at least a portion of the input light rays, after passing through the in-coupling wave vector, the first wave vector, the second recovery wave vector, and again the first wave vector and the second wave vector, is closed.

17. The optical waveguide module according to claim 16, wherein the second recovery wave vector is a wave vector difference between the second wave vector and the first wave vector.

18. The optical waveguide module according to claim 11, wherein the in-coupling grating is configured to provide an in-coupling wave vector through which the input light rays are coupled into the waveguide substrate and transmitted;
the diffraction grating is configured to provide a first wave vector and a second wave vector, and light rays transmitted in the waveguide substrate are subject to pupil expansion and out-coupled through the first wave vector and the second wave vector;
the recovery grating is configured to provide a recovery wave vector to reflect the light rays transmitted to the recovery grating without interacting with the first wave vector and the second wave vector back to the diffraction grating, the recovery wave vector being configured such that a wave vector space formed by at least a portion of the input light rays, after passing through the in-coupling wave vector, the recovery wave vector, and the first wave vector and the second wave vector, is closed.

19. The optical waveguide module according to claim 18, wherein the recovery grating comprises a third recovery grating disposed on a side of the diffraction grating opposite to the in-coupling grating;
the third recovery grating is provide a third recovery wave vector to reflect the light rays transmitted to the third recovery grating without interacting with the first wave vector and the second wave vector back to the diffraction grating, the third recovery wave vector being configured such that a wave vector space formed by at least a portion of the input light rays, after passing through the in-coupling wave vector, the third recovery wave vector, and the first wave vector and the second wave vector, is closed.

20. A head-mounted display device comprising an optical waveguide module, wherein the optical waveguide module comprises:
an optical waveguide structure; and
an optical engine configured to transmit input light rays to the in-coupling grating,
wherein the optical waveguide structure comprises:
a waveguide substrate;
an in-coupling grating configured to in-couple input light rays into the waveguide substrate to transmit the light rays;
a diffraction grating configured to perform pupil expansion on the light rays transmitted in the waveguide substrate and out-couple the light rays; and
a recovery grating configured to reflect the light rays which are not out-coupled and are transmitted to the recovery grating back to the diffraction grating, wherein the recovery grating is configured such that a wave vector space formed by at least portion of input light rays, after interacting with the in-coupling grating, the diffraction grating and the recovery grating, is closed.
